(19) United States
(12) Patent Application Publication
(10) Pub. No.: US 2024/0172340 A1
(43) Pub. Date: May 23, 2024

(54) Method of Calibrating Analog Control Voltage of LED Driver

(71) Applicant: Universal Douglas Lighting Americas, Inc., Madison, AL (US)

(72) Inventors: Scott Price, Madison, AL (US); Thomas M. Poehlman, Madison, AL (US)

(21) Appl. No.: 18/150,639

(22) Filed: Jan. 5, 2023

Related U.S. Application Data
(60) Provisional application No. 63/384,268, filed on Nov. 18, 2022.

(51) Int. Cl. H05B 45/14

(52) U.S. Cl. CPC H05B 45/14

(57) ABSTRACT

A system including a tester and an LED driver cooperate to calibrate the response of the LED driver to a 0-10 volt dimming control signal. The tester stores a calibration command in non-volatile memory in the LED driver. When powered on, the LED driver executes the calibration command by outputting a low load current level while receiving a low dimming control signal from the tester. The LED driver determines a first internal dimming level and then outputs a greater load current to the tester. The tester responds to the greater load current to increase the dimming control signal. The LED driver outputs a still greater load current and determines a second internal dimming level. The LED driver calculates a calibration relationship between the internal dimming levels and the control voltages. In certain embodiments, the first and second dimming levels are determined by averaging over respective intervals.

### RELATED APPLICATION

This application claims the benefit under 35 USC § 119(e) of U.S. Provisional Application No. 63/384,268, filed Nov. 18, 2022, entitled “Method of Calibrating Analog Control Voltage of LED Drive,” which is hereby incorporated by reference in its entirety.

### FIELD OF THE INVENTION

The present disclosure relates generally to lighting systems and, more particularly, to apparatuses to control the intensity of light-emitting diodes (LEDs) in a lighting system responsive to a 0-10 volt DC dimming control signal.

### BACKGROUND

Certain LED lighting systems include LED drivers that are responsive to a DC dimming control signal. The LED driver in an exemplary LED lighting system selectively controls the intensity of the light produced by the LEDs in the lighting system in response to a DC voltage applied between two dimming control input terminals. For example, when a high voltage is applied across the two terminals, the LED driver responds by controlling the LEDs to produce a maximum light intensity. When a low voltage (e.g., at or near 0 volts) is applied across the two terminals, the LED driver responds by controlling the LEDs to produce a minimum light intensity. The LED driver may respond by turning the LEDs off completely.

Two LED drivers having the same circuitry and connected to corresponding configurations of LEDs ideally should produce the same light intensity in response to the same voltage applied across the respective dimming control input terminals; however, in practice, the tolerances of components (e.g., resistance values of resistors, capacitance values of capacitors, voltages across diodes, and the like) may cause otherwise-identical LED drivers to produce different light intensities. For example, such differences in light intensity may be readily apparent when two lighting fixtures are mounted in close proximity and are controlled by a common 0-10 volt dimming controller.

One partial solution to the foregoing problem is to use components with tighter tolerances to minimize variations caused by component values. For example, instead of using commodity resistors and capacitors with 20% tolerances within the LED driver, resistors and capacitors with 5% tolerances or with 1% tolerances can be used to improve the consistency in light intensities produced by multiple LED drivers. However, components with tighter tolerances cost substantially more than commodity components, and the improved consistency may not solve the problem entirely.

### SUMMARY

A need exists for LED drivers that produce consistent light intensities notwithstanding differences in the parametric values of the components within the LED drivers.

One aspect of the embodiments disclosed herein is a system that includes a tester and an LED driver that cooperate to calibrate the response of the LED driver to a 0-10 volt dimming control signal. The tester stores a calibration command in non-volatile memory in the LED driver. When powered on, the LED driver executes the calibration command by outputting a low load current level while receiving a low dimming control signal from the tester. The LED driver determines a first internal dimming level and then outputs a greater load current to the tester. The tester responds to the greater load current to increase the dimming control signal. The LED driver outputs a still greater load current and determines a second internal dimming level. The LED driver calculates a calibration relationship between the internal dimming levels and the control voltages. In certain embodiments, the first and second dimming levels are determined by averaging over respective intervals.

Another aspect of the embodiments disclosed herein is a system for calibrating an LED driver. The LED driver receives an AC power input. The LED driver generates an output current via a current output terminal and a current return terminal. The LED driver includes an externally accessible non-volatile memory. The LED driver is responsive to a 0-10 volt dimming control signal to generate an internal dimming signal. The LED driver varies a magnitude of the output current responsive to the internal dimming signal. The system comprises a tester. The tester is configured to store a calibration command in the externally accessible non-volatile memory of the LED driver. The tester is configured to selectively provide AC power to the AC power input of the LED driver. The tester is configured to receive and measure the output current from the LED driver. The tester is configured to provide at least first voltage and a second voltage as 0-10 volt dimming control signals to the LED driver. The tester provides the first voltage to the LED driver when power is applied to the AC power input of the LED drive. The first voltage of the control signal corresponds to a minimum current magnitude to be generated by the LED driver. The tester provides the second voltage of the control signal to the LED driver when the output current increases from a first minimum current magnitude to a second current magnitude. The second current magnitude is less than a maximum magnitude of the output current. The second voltage of the control signal corresponds to a maximum current magnitude to be provided by the LED driver. The system further comprises a state machine within the LED driver. The state machine is configured to access the non-volatile memory to receive the calibration command. The state machine is configured to generate the output current at the minimum current magnitude and determine a first value of the internal dimming signal corresponding to the first value of the control signal. The state machine is configured to generate the output current at the second current magnitude. The state machine is configured to detect the increase of the internal dimming signal to the second value. The state machine is configured to generate the output current at the maximum current level and determine a second value of an internal dimming signal corresponding to the second value of the control signal. The state machine is configured to calculate a calibration relationship between the internal dimming signal wherein the calibration relationship comprises the first value of the internal dimming signal as an offset value and further comprises a slope determined by a difference between the second value and the first value of the internal dimming signal divided by a difference between the second voltage and the first voltage of the control signal.

In certain embodiments, the calibration relationship is stored within the LED driver and is used to determine the current level to generate each time the LED driver is turned on until a new calibration command is stored in the externally accessible non-volatile memory of the LED driver.

In certain embodiments, the state machine of the LED driver is configured to clear the calibration command stored in the externally accessible non-volatile memory after calculating the calibration relationship.

In certain embodiments, the state machine of the LED driver is configured to output the load current at a zero magnitude after calculating the calibration relationship to indicate to the tester that the calibration relationship has been calculated.

In certain embodiments, the calibration relationship comprises:

V_{CALC}=OFFSET+(SLOPE×V_{MEAS})

wherein V_{MEAS} is the value of the internal dimming signal responsive to the voltage of the dimming control signal applied to the LED driver; V_{CALC} is an internal voltage that determines a current level to generate; OFFSET is the first value of the internal dimming signal; and SLOPE is the difference between the second value and the first value of the internal dimming signal divided by a difference between the second voltage and the first voltage of the control signal.

In certain embodiments, the LED driver is configured to generate a setpoint for the load current in accordance with:

I_{OUT}=I_{MIN}+((I_{MAX}−I_{MIN})×((V_{CALC}−V_{FULLDIM})/(V_{FULLBRIGHT}−V_{FULLDIM})))

wherein I_{OUT} is generated load current setpoint; V_{FULLDIM} is the lowest voltage of the control signal to produce a minimum load current; V_{FULLBRIGHT} is the highest voltage of the control signal to produce a maximum load current; I_{MIN} is a minimum load current setpoint corresponding to the control signal being received at V_{FULLDIM}; and I_{MAX} is a maximum load current setpoint corresponding to the control voltage being received at V_{FULLBRIGHT}.

In certain embodiments, the LED driver is configured to average the internal dimming signal over the first interval to generate a first average level; average the internal dimming signal over the third interval to generate a second average level; and generate the calibration relationship based on the first and second average levels of the internal dimming signal.

In certain embodiments, the calibration relationship is:

V_{CALC}=OFFSET+(SLOPE×V_{MEAS})

wherein V_{MEAS} is the value of the internal dimming signal responsive to the voltage of the dimming control signal applied to the LED driver; V_{CALC} is the internal dimming signal that determines a current level to generate; OFFSET is the first average level of the internal dimming signal; and SLOPE is the difference between the second average and the first average level of the internal dimming signal divided by a difference between the second voltage and the first voltage of the control signal.

In certain embodiments, the LED driver is configured to generate a setpoint for the load current in accordance with:

I_{OUT}=I_{MIN}+((I_{MAX}−I_{MIN})×((V_{CALC}−V_{FULLDIM})/(V_{FULLBRIGHT}−V_{FULLDIM})))

wherein I_{OUT} is generated load current setpoint; V_{FULLDIM} is the lowest voltage of the control signal to produce a minimum load current; V_{FULLBRIGHT} is the highest voltage of the control signal to produce a maximum LED current; I_{MIN} is a minimum load current setpoint corresponding to the control signal being received at V_{FULLDIM}; and I_{MAX} is a maximum load current setpoint corresponding to the control voltage being received at V_{FULLBRIGHT}.

Another aspect of the embodiments disclosed herein is method of calibrating an LED driver that receives a 0-10 volt dimming control signal from an external source, wherein the LED driver generates an internal dimming signal having values responsive to voltages of the 0-10 volt dimming control signal, and wherein the LED driver outputs a load current having a magnitude responsive to the internal dimming signal. The method comprises storing a calibration command in a non-volatile memory of the LED driver. The method further comprises accessing the calibration command in the non-volatile memory with a microcontroller within the LED driver. The method further comprises receiving a known first voltage via the dimming control signal and generating an internal dimming signal at a first level responsive to the first voltage. The method further comprises outputting the load current at a first magnitude for a first interval having a first selected duration. The method further comprises outputting the load current at a second magnitude greater than the first magnitude for a second interval having a second selected duration. The method further comprises receiving a known second voltage via the dimming control signal and generating the internal dimming signal at a second level responsive to the second voltage. The method further comprises outputting the load current at a third magnitude greater than the second magnitude for a third interval having a third selected duration. The method further comprises generating a calibrated relationship between the levels of the internal dimming signal and the voltages of the dimming control signal. The method further comprises storing the calibrated relationship to convert subsequent changes in the voltage of the dimming control signal to changes of the level of the internal dimming signal.

In certain embodiments, the method further comprises outputting the load current at a fourth magnitude after storing the calibrated relationship.

In certain embodiments, the LED driver is configured to reset when outputting the load current at the fourth magnitude.

In certain embodiments, the fourth magnitude of the load current is substantially zero.

In certain embodiments, the control voltage is generated by an automated tester.

In certain embodiments, the LED driver clears the calibration command stored in the externally accessible non-volatile memory after generating the calibration relationship.

In certain embodiments, the internal dimming signal is averaged over the first interval to generate a first average level; the internal dimming signal is averaged over the third interval to generate a second average level; and the first average level and the second average level are used to generate the calibration relationship.

In certain embodiments, the calibration relationship is:

V_{CALC}=OFFSET+(SLOPE×V_{MEAS})

wherein V_{MEAS} is the value of the internal dimming signal responsive to the voltage of the dimming control signal applied to the LED driver; V_{CALC} is the internal dimming signal that determines a current level to generate; OFFSET is the first average level of the internal dimming signal; and SLOPE is the difference between the second average and the first average level of the internal dimming signal divided by a difference between the second voltage and the first voltage of the control signal.

In certain embodiments, the LED driver generates a setpoint for the load current in accordance with:

I_{OUT}=I_{MIN}+((I_{MAX}−I_{MIN})×((V_{CALC}−V_{FULLDIM})/(V_{FULLBRIGHT}−V_{FULLDIM})))

wherein I_{OUT} is generated load current setpoint; V_{FULLDIM} is the lowest voltage of the control signal to produce a minimum load current; V_{FULLBRIGHT} is the highest voltage of the control signal to produce a maximum load current; I_{MIN} is a minimum load current setpoint corresponding to the control signal being received at V_{FULLDIM}; and I_{MAX} is a maximum load current setpoint corresponding to the control voltage being received at V_{FULLBRIGHT}.

In certain embodiments, the calibration relationship is:

V_{CALC}=OFFSET+(SLOPE×V_{MEAS})

wherein V_{MEAS} is the value of the internal dimming signal responsive to the voltage of the dimming control signal applied to the LED driver; V_{CALC} is the internal dimming signal that determines a current level to generate; OFFSET is the first level of the internal dimming signal; and SLOPE is the difference between the second and the first level of the internal dimming signal divided by a difference between the second voltage and the first voltage of the control signal.

In certain embodiments, the LED driver generates a setpoint for the load current in accordance with:

I_{OUT}=I_{MIN}+((I_{MAX}−I_{MIN})×((V_{CALC}−V_{FULLDIM})/(V_{FULLBRIGHT}−V_{FULLDIM})))

wherein I_{OUT} is generated load current setpoint; V_{FULLDIM} is the lowest voltage of the control signal to produce a minimum load current; V_{FULLBRIGHT} is the highest voltage of the control signal to produce a maximum load current; I_{MIN} is a minimum load current setpoint corresponding to the control signal being received at V_{FULLDIM}; and I_{MAX} is a maximum load current setpoint corresponding to the control voltage being received at V_{FULLBRIGHT}.

### BRIEF DESCRIPTIONS OF THE SEVERAL VIEWS OF THE DRAWINGS

FIG. 1 illustrates a block diagram of an LED driver that receives an AC input voltage from a voltage source 110 and that generates a DC output voltage to drive an LED load.

FIG. 2 illustrates a detailed circuit diagram of the DC dimmer control input interface of FIG. 1.

FIG. 3 illustrates a test configuration in which the LED driver of FIG. 1 is coupled to a manufacturing tester to calibrate the LED driver.

FIG. 4 illustrates a data structure for a calibration command stored by the manufacturing tester of FIG. 3 into the NFC circuit of the LED driver of FIG. 1.

FIG. 5 illustrates a bit structure for the calibration bit field of the data structure of FIG. 4.

FIG. 6 illustrates examples of the calibration payload bytes of the data structure of FIG. 4 wherein six calibration payload bytes determine dwell times of the LED driver at three selected current levels during a calibration process disclosed herein.

FIG. 7 illustrates a flowchart representing a state machine implemented in the microcontroller of the LED driver of FIG. 1 to perform the calibration process.

FIG. 8 illustrates the flowchart of FIG. 7 juxtaposed with a flowchart representing operations of the manufacturing tester of FIG. 3 during the calibration process.

FIG. 9 illustrates an upper waveform that represents normalized output current generated by the LED driver of FIG. 1 coupled to the manufacturing tester of FIG. 3 when the LED driver and the manufacturing tester are performing the calibration process; and further illustrates a lower waveform that represents a dimming voltage generated by the manufacturing tester and applied to the LED driver during the calibration process.

FIG. 10 illustrates normalized output currents responsive to dimming voltages for four devices prior to calibration of the four devices using the calibration process.

FIG. 11 illustrates normalized output currents responsive to dimming voltages for the same four devices as in FIG. 10 after calibration of the four devices using the calibration process.

FIG. 12 illustrates the normalized output currents versus dimming voltages as shown in FIG. 10 prior to calibration, the current scales and the voltage scales enlarged to show the transitions (elbows) of the currents to the maximum current level as the dimming voltage nears a dimming voltage corresponding to the maximum current level, the currents for the four devices reaching the maximum current level over a relatively wide range of dimming voltages.

FIG. 13 illustrates the normalized output currents versus dimming voltages as shown in FIG. 11 after calibration, the current scales and the voltage scales enlarged to show the transitions (elbows) of the current waveforms to the maximum current level as the dimming voltage nears a dimming voltage corresponding to the maximum current level, the output currents of the four devices reaching the maximum current over a relatively narrow voltage range in comparison to the voltage range illustrated in FIG. 12.

FIG. 14 illustrates the normalized output currents versus dimming voltages as shown in FIG. 10 prior to calibration, the current scales and the voltage scales enlarged to show the transitions (elbows) of the currents between a zero current level and a minimum current level and the increases from the minimum current level to rising current levels as the dimming voltage increases from a low dimming voltage to higher dimming voltages, the currents for the four devices transitioning between different levels over a relatively wide voltage range.

FIG. 15 illustrates the normalized output currents versus dimming voltages as shown in FIG. 11 after calibration, the current scales and the voltage scales enlarged to show the transitions (elbows) of the currents between a zero current level and a minimum current level and the increases from the minimum current level to rising current levels as the dimming voltage increases from a low dimming voltage to higher dimming voltages, the currents for the four devices transitioning between different levels over a relatively narrow voltage range in comparison to the currents illustrated in FIG. 14.

### DETAILED DESCRIPTION

The following detailed description of embodiments of the present disclosure refers to one or more drawings. Each drawing is provided by way of explanation of the present disclosure and is not a limitation. Those skilled in the art will understand that various modifications and variations can be made to the teachings of the present disclosure without departing from the scope of the disclosure. For instance, features illustrated or described as part of one embodiment can be used with another embodiment to yield a still further embodiment.

The present disclosure is intended to cover such modifications and variations as come within the scope of the appended claims and their equivalents. Other objects, features, and aspects of the present disclosure are disclosed in the following detailed description. One of ordinary skill in the art will understand that the present discussion is a description of exemplary embodiments only and is not intended as limiting the broader aspects of the present disclosure.

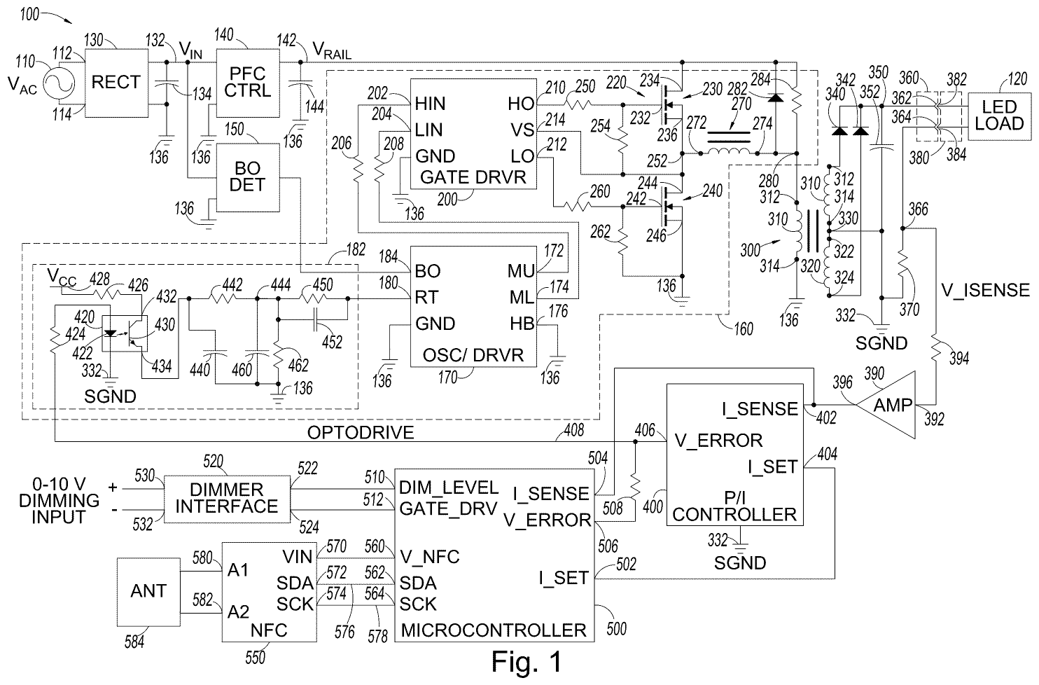

FIG. 1 illustrates a block diagram of an LED driver 100 that receives an AC input voltage (V_{AC}) from a voltage source 110 via a first AC voltage input terminal 112 and a second AC voltage input terminal 114. The LED driver generates a DC output voltage to drive an LED load 120.

The LED driver 100 includes a rectifier (RECT) 130 that receives the AC input voltage from the voltage source 110 and that generates a rectified DC voltage (VIN) on a first voltage bus 132. The first voltage bus is connected to a first terminal of a filter capacitor 134, which has a second terminal connected to a primary ground reference 136.

The rectified DC voltage on the first voltage bus 132 is provided as an input to a power factor controller (PFC CTRL) 140. The power factor controller operates in a conventional manner to generate a conditioned DC voltage (V_{RAIL}) on a second voltage bus 142. A filter capacitor 144 is connected between the second voltage bus and the primary ground reference 136. The conditioned DC voltage is provided to the high voltage switching circuit described below. The power factor controller also operates to provide power factor correction to reduce distortion on the AC input voltage. Power factor controllers are well known. One power factor controller suitable for the LED driver disclosed herein is based on an MPS MP44014 Boundary Mode PFC Controller integrated circuit from Monolithic Power Systems Inc. of Kirkland, Washington. The integrated circuit is coupled to other components (e.g., resistors, capacitors, inductors, diodes, transistors, and the like) to complete the power factor controller. A detailed description of the power factor controller is not necessary to the understanding of the improvements disclosed herein.

The rectified DC voltage on the first voltage bus 132 is also provided as an input to a brownout detector (BO DET) circuit 150. The brownout detector circuit operates in conventional manner to detect when the rectified DC voltage drops below a selected voltage level. When the rectified DC voltage drops below the selected voltage level, the brownout detector circuit generates an active brownout signal on a brownout output (BO) terminal 152 that is coupled to switching circuitry described below. Brownout detectors are well-known in the art and may be implemented in various configurations.

The LED driver 100 includes switching circuitry 160 that operates as a DC-to-AC inverter to generate a high voltage AC signal. The switching circuitry includes an oscillator/driver circuit (OSC/DRVR) 170 that generates a first (upper) drive signal on a first output (MU) terminal 172 and that generates a second (lower) drive signal on a second output (ML) terminal 174. The two drive signals are referenced to a half-bridge reference voltage on a third (HB) terminal 176, which is connected to the primary ground reference 136.

The oscillator/driver circuit 170 includes an internal oscillator that is responsive to a magnitude of a timing current flowing out of a timing resistor (RT) terminal 180 to generate time-varying drive signals on the first and second terminals having a frequency that is determined by the magnitude of the timing current. The drive signals on the two terminals are timed so that only one of the signals is active at any time. In the illustrated embodiment the frequency varies from approximately 50 kHz when the timing current is approximately 0.2 milliamperes to approximately 280 kHz when the timing current is approximately 1.2 milliamperes. The timing current is controlled by a timing current control circuit 182 described below.

The oscillator/driver circuit 170 is also responsive to the brownout signal received on a brownout input (BO) terminal 184 from the brownout detector 150 to turn off the internal oscillator when the magnitude of the rectified DC voltage (VIN) is too low.

In the illustrated embodiment, the oscillator/driver circuit 170 is implemented by an ON Semiconductor NCP1392B High-Voltage Half-Bridge Driver with Inbuilt Oscillator, which is commercially available from Semiconductor Components Industries, LLC, of Phoenix, Arizona. Other oscillator/driver circuits may also be used.

The switching circuitry 160 further includes a gate driver circuit 200 having a high driver input (HIN) terminal 202 and a low driver input (LIN) terminal 204. The upper drive signal on the first output terminal 172 of the oscillator/driver circuit 170 is connected to the high driver input terminal of the gate driver circuit via an input resistor 206. The lower drive signal on the second output terminal 174 of the oscillator/driver circuit is connected to the low driver input terminal of the gate driver circuit via an input resistor 208. The gate driver circuit buffers and level shifts the received input signals. The gate driver circuit generates a high-side driver output signal on a high-side output (HO) terminal 210 responsive to the signal on the high driver input terminal and generates a low-side driver output signal on a low-side output (LO) 212 responsive to the signal on the low driver input terminal. The high-side driver output signal is referenced to a reference terminal 214 of the gate driver circuit.

The switching circuit 160 further includes a half-bridge switch 220 comprising a first power MOSFET 230 having a gate terminal 232, a drain terminal 234 and a source terminal 236. The switching circuit further comprises a second power MOSFET 240 having a gate terminal 242, a drain terminal 244 and a source terminal 246.

The high-side driver output signal from the high-side output terminal 210 of the gate driver circuit 200 is coupled to the gate input terminal 236 of the first power MOSFET 230 via an input resistor 250. The drain terminal 234 of the first power MOSFET is connected to the second voltage bus 142 to receive the conditioned DC voltage (V_{RAIL}). The source terminal 236 of the first power MOSFET is connected to an output node 252. The gate terminal and the source terminal of the first power MOSFET are connected via a biasing resistor 254. The output node is connected to the reference terminal 214 of the gate driver circuit.

The low-side driver output signal from the low-side output terminal 212 of the gate driver circuit 200 is coupled to the gate input terminal 242 of the second power MOSFET 240 via an input resistor 260. The drain terminal 244 of the second power MOSFET is connected to the output node 252. The source terminal 246 of the second power MOSFET is connected to the primary ground reference 136. The gate terminal and the source terminal of the second power MOSFET are connected via a biasing resistor 262.

The switching circuit 160 further includes an output choke (inductor) 270. The output choke has a first terminal 272 and a second terminal 274. In the illustrated embodiment, the output choke is shown as a single choke; however, in other embodiments, the output choke may comprise two chokes connected in series or in parallel to obtain a desired inductive impedance.

The first terminal 272 of the output choke 270 is connected to the output node 252 of the half-bridge switch 220. The second terminal 274 of the output choke is connected to an output node 280 of the switching circuit 160. The output node of the switching circuit is connected to the anode of a diode 282, which has a cathode connected to the second voltage (V_{RAIL}) bus 142. A resistor 284 is connected across the diode between the output node and the second voltage bus. In the illustrated embodiment, the resistor has a resistor of approximately 1.3 megohms.

The output node 280 of the switching circuit 160 is connected to a first terminal 304 of a primary winding 302 of an isolation transformer 300. The primary winding has a second terminal 306. The second terminal of the primary winding is connected to the primary ground reference 136.

The isolation transformer 300 has a first secondary winding 310 having a first terminal 312 and a second terminal 314. The isolation transformer has a second secondary winding 320 having a first terminal 322 and a second terminal 324. The second terminal of the first secondary winding and the first terminal of the second secondary winding are connected together at a common node 330, which is connected to a secondary ground (SGND) reference 332. The secondary ground reference is electrically isolated from the primary ground reference 136 by the isolation transformer.

The first terminal 312 of the first secondary winding 310 of the isolation transformer 300 is connected to the anode of a first rectifier diode 340. The second terminal 324 of the second secondary winding 320 of the isolation transformer is connected to the anode of a second rectifier diode 342. Each rectifier diode has a respective cathode, and the two cathodes are connected together at a load output node 350. An output filter capacitor 352 is connected between the output node and the secondary ground reference 332.

The load output node 350 is connected to a first (power) terminal 362 of an output connector 360. A second (return) terminal 364 of the output connector is connect to a sensing node 366. The sensing node is connected to the secondary ground reference 332 via a current sensing resistor 370. In the illustrated embodiment, the current sensing resistor has a low resistance of approximately 132.75 milliohms. Although only one resistor is shown, the current sensing resistor may comprise multiple resistors connected in parallel to achieve a desired low resistance. When current flows through the current sensing resistor, a sensed voltage (V_ISENSE) is produced on the on the sensing node that is proportional to the current flowing through the current sensing resistor.

In FIG. 1, the LED load 120 is connected between the first (power) terminal 362 and the second (return) terminal 364 of the output connector 360 via a respective first (power) terminal 382 and a respective second (return) terminal 384 of a load connector 380. The LED load can be disconnected from the output connector and replaced with a different load in test equipment during a calibration process described below. When the LED load is connected to the output connector, the current through the LED load also passes through the current sensing resistor 370. Thus, the voltage (V_ISENSE) produced on the sensing node 366 is proportional to the current through the LED load.

The sensing node 366 is coupled to an input 392 of a buffer amplifier 390 via a high-resistance resistor 394 so that the sensed voltage appears on the input of the buffer amplifier without a significant effect on the current flowing through the current sensing resistor 370. The buffer amplifier buffers and amplifies the sensed voltage and generates a buffered output voltage on an output terminal 396. The buffered output voltage is proportional to the sensed voltage and thus is proportional to the current flowing through the current sensing resistor.

The buffered output voltage produced by the buffer amplifier 390 is provided as a first input signal to a first (current sense) input terminal 402 of a proportional integral (P/I) controller 400. The current sense input terminal is labeled as I_SENSE; however, it should be understood that the signal applied to the current sense input terminal is a voltage proportional to the sensed current as described above. The P/I controller has a second input terminal 404 labeled as I_SET that receives a second input signal having a voltage proportional to a desired current (e.g., a current setpoint) through the LED load 120. The P/I controller includes an operational amplifier and related support circuitry that configures the operational amplifier to operate as a proportional integral controller to produce an output signal that is responsive to differences in the two input signals applied to the first and second input terminals. For example, in one embodiment, the operational amplifier comprises an ON Semiconductor LMB321 operational amplifier or an equivalent from other sources.

The P/I controller 400 receives the two input signals on the first input terminal 402 and the second input terminal 404 and generates an output voltage on a V_ERROR output terminal 406. The output signal is provided to a signal line 408, which is identified as OPTODRIVE in FIG. 1. The output signal has a magnitude that varies in response to the difference between the voltages on the first and second input terminals.

The output voltage (OPTODRIVE) on the line 408 from the V_ERROR output terminal 406 of the P/I controller 400 is coupled to the timing current control circuit 182 that controls the timing current flowing out of the timing resistor (RT) terminal 180 of the oscillator/driver circuit 170. Within the current control circuit, the output voltage from the P/I controller is applied to the anode of a photodiode 422 within an optical coupler 420 via a current limiting resistor 424. The cathode of the photodiode is referenced to the secondary ground reference 332. As described below, the optical coupler operates to electrically isolate the signals referenced to the secondary ground reference from the signals referenced to the primary ground reference 136.

The photodiode 422 is responsive to the magnitude of the OPTODRIVE signal to produce more or less light. The optical coupler 420 includes a phototransistor 430 having a beta parameter responsive to the light emitted by the photodiode 422. The phototransistor includes a collector terminal 432 and an emitter terminal 434. The collector terminal of the phototransistor is connected to a supply voltage (V_{CC}) source 428 via a first timing circuit resistor 426. The supply voltage source is generated elsewhere in the switching circuitry 160 in a conventional manner. The emitter terminal of the phototransistor is connected to the primary ground reference 136 by a small (e.g., approximately 1 microfarad) filter capacitor 440. The emitter terminal is also connected to a first terminal of a second timing circuit resistor 442. A second terminal of the second timing circuit resistor is connected to a timing voltage node 444. The timing voltage node is connected to the timing resistor (RT) terminal 180 of the oscillator/driver circuit 170 via a third timing circuit resistor 450. A small (e.g., approximately 1,000 picofarads) noise filter capacitor 452 is connected across the third timing circuit resistor between the timing voltage node and the timing resistor (RT) terminal. The timing voltage node is connected to the primary ground reference 136 via a timing voltage capacitor 460. The timing voltage capacitor is a relatively large capacitor (e.g., approximately 100 microfarads). A fourth timing circuit resistor 462 is connected across the timing voltage capacitor from the timing voltage node to the primary ground reference.

As briefly discussed above, the oscillator/driver circuit 170 includes an internal oscillator that is responsive to a magnitude of a timing current flowing out of the timing resistor (RT) terminal 180. The oscillator/driver circuit includes an internal voltage reference that maintains a fixed voltage (e.g., 3.5 volts) on the timing resistor (RT) terminal. Thus, the timing current flowing out of the timing resistor (RT) terminal is determined by the voltage across the third timing circuit resistor 450. The voltage across the third timing circuit resistor is the difference between the internal fixed reference voltage and the voltage on the timing node 444. The voltage on the timing node is the voltage across the timing voltage capacitor 460.

When the magnitude of the OPTODRIVE signal applied to the anode of the photodiode 422 increases, the photodiode emits increased light, which increases the beta of the phototransistor 430. The increased beta increases the conductivity of the phototransistor, which increases the voltage on the timing node 444. The increased voltage on the timing node reduces the voltage drop across the third timing circuit resistor 450. The reduced voltage drop reduces the current through the third timing resistor and out of the timing resistor (RT) terminal 180 of the oscillator/driver circuit 170. The reduced current reduces the frequency of the signals generated by the oscillator/driver circuit on the MU output terminal 172 and the ML output terminal 174.

When the magnitude of the OPTODRIVE signal applied to the anode of the photodiode 422 decreases, the photodiode emits decreases light, which decreases the beta of the phototransistor 430. The decreased beta decreases the conductivity of the phototransistor, which decreases the voltage on the timing node 444. The decreased voltage on the timing node increases the voltage drop across the third timing circuit resistor 450. The increased voltage drop increases the current through the third timing resistor and out of the timing resistor (RT) terminal 180 of the oscillator/driver circuit 170. The increased current increases the frequency of the signals generated by the oscillator/driver circuit on the MU output terminal 172 and the ML output terminal 174.

As described above, the outputs of the oscillator/driver circuit 170 are applied as the inputs to the gate driver circuit 200, which drives the first power MOSFET 230 and the second power MOSFET 240 in the half-bridge switch 220 to generate a time-varying voltage on the output node 252 of the half-bridge switch. The time-varying voltage is coupled through the output choke 270 to produce a time-varying generally sinusoidal voltage on the output node 280 of the switching circuit 160. Because of the output choke, sinusoidal voltage on the output node of the switching circuit has an amplitude that varies with the switching frequency. When the switching frequency increases, the impedance of the output choke increases, which reduces the amplitude of the sinusoidal voltage. When the switching frequency decreases, the impedance of the output choke decreases, which increases the amplitude of the sinusoidal voltage. Accordingly, controlling the voltage across the timing voltage capacitor 460 and thus controlling the timing current flowing out of the timing resistor (RT) terminal 180 of the oscillator/driver circuit 170 controls the amplitude of the sinusoidal voltage. The amplitude of the DC load voltage on the load output node 350 thus increases when the switching frequency decreases and decreases when the switching frequency increases.

The described relationship between the switching frequency and the load voltage allows the load current to be easily controlled. When the load voltage is too high, the sensed load current (I_SENSE) as represented by the voltage V_ISENSE is greater than the desired load current as represented by the voltage applied to the I_SET input terminal 404 of the P/I controller 400, which causes the magnitude of the OPTODRIVE signal on the V_ERROR output terminal 406 to decrease. The decreased magnitude of the OPTODRIVE signal causes the photodiode 422 in the optical coupler 420 to emit decreased light. The beta of the phototransistor 430 reduces, which reduces the voltage on the timing voltage node 444. The decreased voltage on the timing node increases the timing current flowing out of the timing resistor (RT) terminal 180 of the oscillator/driver circuit 170. The increased timing current increases the switching frequency, which reduces the load voltage and the load current as described above.

When the load voltage is too low, the sensed load current as represented by the voltage V_ISENSE is less than the desired load current as represented by the voltage applied to the I_SET input terminal 404 of the P/I controller 400, which causes the magnitude of the OPTODRIVE signal on the V_ERROR output terminal 406 to increase. The increased magnitude of the OPTODRIVE signal causes the photodiode 422 in the optical coupler 420 to emit increased light. The beta of the phototransistor 430 increases, which increases the voltage on the timing voltage node 444. The increased voltage on the timing node decreases the timing current flowing out of the timing resistor (RT) terminal 180 of the oscillator/driver circuit 170. The decreased timing current decreases the switching frequency, which increases the load voltage and the load current as described above.

The P/I controller 400 continuously monitors the sensed load current and increases and decreases the magnitude of the OPTODRIVE signal to control the current flowing through the phototransistor 430 in the optical coupler 420 to maintain the voltage on the timing voltage node 444 at a voltage that maintains the load current at the desired magnitude represented by the magnitude of the signal applied to the I_SET input terminal 404 of the P/I controller.

The magnitude of the signal applied to the I_SET input terminal 404 of the P/I controller 400 is controlled by an I_SET output signal from an output terminal 502 of a microcontroller 500. The microcontroller increases the voltage level of the signal to increase the desired magnitude of the load current. The microcontroller decreases the voltage level of the signal to decrease the desired magnitude of the load current. The microcontroller further includes an I_SENSE input terminal 504, which is connected to the output terminal 396 of the buffer amplifier 390, and a V_ERROR input terminal 506, which is connected to the V_ERROR output terminal 406 of the P/I controller 400 via a resistor 508. In the illustrated embodiment, the microcontroller comprises an XMC1300 microcontroller, which is commercially available from Infineon Technologies AG of Munich, Germany, or another suitable microcontroller.

The microcontroller 500 includes a dimming level (DIM_LEVEL) input terminal 510 and dimmer interface gate driver (GATE_DRV) output terminal 512. A dimming level input signal is received on the dimming level input terminal from a DIM_LEVEL output terminal 522 of a dimmer interface 520. The dimmer interface gate driver output terminal is connected to a GATE_DRV input terminal 524 of the dimmer interface. As described below, the dimmer interface generates the dimming level signal on the DIM_LEVEL output terminal in response to the GATE_IN input terminal.

The dimmer interface 520 receives a conventional 0-10 volt dimming input signal that is applied across a dimming level high (+) input terminal 530 and a dimming level low (−) input terminal 532. The dimming level high input terminal is often referred to as the violet terminal, and the dimming level low input terminal is often referred to as the pink terminal in accordance with wiring codes for low-voltage dimming circuits. The two terminals are connected to a conventional 0-10 volt dimming controller (not shown), which generates a DC voltage on the dimming level high input terminal that is positive with respect to the voltage on the dimming level low input terminal. A relatively low DC voltage (e.g., at or near 0 volts) represents a low (or off) light intensity level. A relatively high DC voltage (e.g., at or near 10 volts represents a high (or maximum) light intensity level. As described below, the dimming interface receives the 0-10 volt dimming signal and generates the dimming level signal on the DIM_LEVEL output terminal 522 of the dimmer interface. As further described below, the microcontroller 500 is responsive to the dimming level signal received on the dimming level input terminal 510 to adjust I_SET signal on the output terminal 502.

The microcontroller 500 also communicates with a near field communication (NFC) circuit 550. The microcontroller includes a voltage output terminal 560, a bidirectional serial data (SDA) terminal 562 and a bidirectional serial clock (SCK) terminal 564. The NFC circuit includes a voltage supply terminal 570, a bidirectional serial data terminal 572 and a bidirectional serial clock terminal 574. The serial data terminals of the microcontroller and the NFC circuit are interconnected by a serial data line 576. The serial clock terminals of the microcontroller and the NFC circuit are interconnected by a serial clock line 578. The NFC circuit further includes a first antenna terminal 580 and a second antenna terminal 582. The two antenna terminals are connected to an antenna 584.

The NFC circuit 550 operates in two modes. In a first mode, the NFC circuit is positioned proximate to an NFC communication device (not shown) that communicates wirelessly with the NFC circuit via radio frequency signals transmitted to the antenna 584. The NFC circuit derives internal power from the received radio frequency signals and stores data within the NFC circuit. The format of the data stored in the NFC circuit is described below.

The microcontroller 500 activates the voltage output terminal 560 to provide voltage to the voltage supply terminal 570 of the NFC circuit 550 to cause the NFC circuit to operate in second mode. In the second mode, the NFC circuit communicates with the microcontroller to selectively send data to the microcontroller and to selectively receive data from the microcontroller via the serial data line 576. The data is transferred in synchronism with a serial clock signal on the serial clock line 578. Protocols for transmitting data bidirectionally are well known and are not described herein.

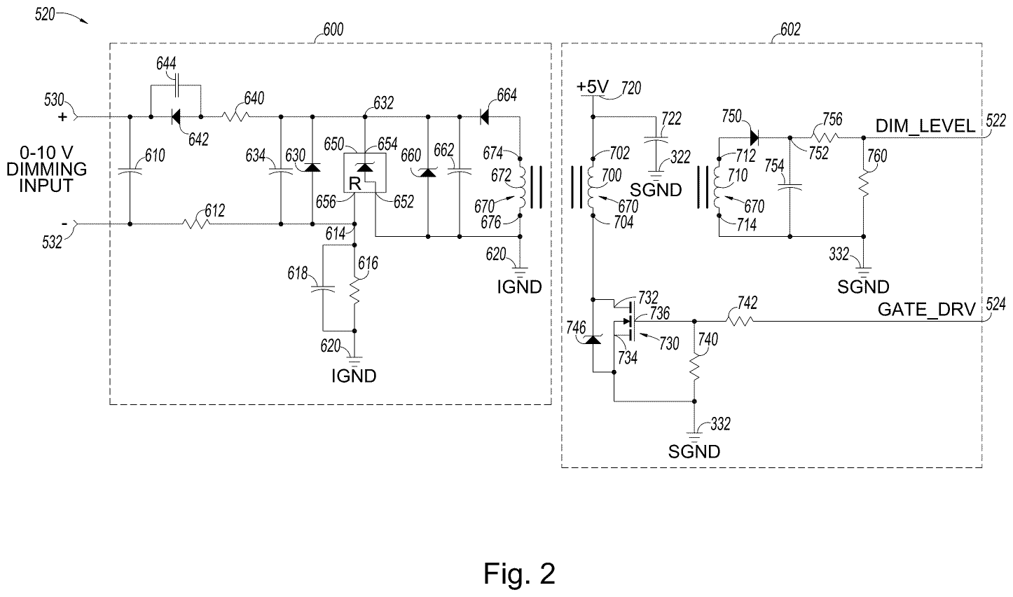

Because of the high voltages generated within the driver circuit 100, the driver circuit is electrically isolated from the dimming voltage input by the dimmer interface 520. Electrical isolation is provided by transformer coupling the output of the dimmer interface to the microcontroller 500 as illustrated in more detail in FIG. 2. The dimmer interface includes an input section 600 and an output section 602. The input section receives the 0-10 volt dimming control signal via the dimming level high input terminal 530 and the dimming level low input terminal 532 as described above. The output section receives the GATE_DRV signal from the microcontroller 500 on the GATE_DRV input terminal 524 and generates the DIM_LEVEL signal on the output terminal 522. As described below, the input section is electrically isolated from the output section.

Within the input section 600, an input capacitor 610 is coupled between the dimming level high input terminal 530 and the dimming level low input terminal 532. The dimming level high input terminal is coupled to a first terminal of a first dimming interface resistor 612. A second terminal of the first dimming resistor is coupled to a reference node 614 having a fixed voltage as described below. The reference node is coupled to a first terminal of a second dimming interface resistor 616 and to the first terminal of a first dimming interface capacitor 618. Respective second terminals of the second dimming interface resistor and the first dimming interface capacitor are connected to a dimming interface ground reference 620. The dimming interface ground reference is electrically isolated from the primary ground reference 136 and from the secondary ground reference 332. The dimming interface ground reference is labeled as IGND in FIG. 2.

A first dimming interface diode 630 has an anode connected to the reference node 614 and has a cathode connected to an input section voltage node 632. A second dimming interface capacitor 634 is connected across the first dimming interface diode from the reference node to the input section voltage node.

A third dimming interface resistor 640 has a first terminal connected to the input section voltage node 632 and has a second terminal connected to the anode of a second dimming interface diode 642. A cathode of the second dimming interface diode is connected to the dimming level high input terminal 530. A third dimming interface capacitor 644 is connected across the second dimming interface diode.

A programmable reference 650 has an anode terminal 652 connected to the dimming interface ground reference 620 and has a cathode terminal 654 connected to the input section voltage node 632. A reference terminal (R) 656 of the programmable reference is connected to the reference node 614 of the input section 600.

A Zener diode 660 has an anode connected to the dimming interface ground reference 620 and has a cathode connected to the input section voltage node 632. In the illustrated embodiment, the Zener diode has a clamping voltage of approximately 18 volts. A fourth dimming interface capacitor 662 is coupled across the Zener diode from the input section voltage node to the dimming interface ground reference.

The input section voltage node 632 is connected to a cathode of a third dimming interface diode 664. An anode of the third dimming interface diode is connected to a first terminal 674 of a first secondary winding 672 of a dimming interface isolation transformer 670. A second terminal 676 of the first secondary winding of the dimming interface isolation transformer is connected to the dimming interface ground reference 620. Further details about the dimming interface isolation transformer are described below.

In the illustrated embodiment, the programmable reference 650 is a TL431 precision programmable reference, which is commercially available from Texas Instruments of Dallas, Texas, or an equivalent from other sources. The programmable reference operates in a known manner to keep the reference terminal (R) 656 at a constant voltage (e.g., 2.5 volts) with respect to the anode 652. Thus, the reference node 614 is maintained at 2.5 volts with respect to the dimming interface ground reference 620.

The voltage on the input section voltage node 632 with respect to the dimming interface ground reference 620 is determined by the dimming voltage applied across the dimming level high input terminal 530 and the dimming level low input terminal 532 in the following manner.

As discussed above, the constant voltage on the reference terminal 656 of the programmable reference 650 maintains the reference node 614 at a constant 2.5 volts. In the illustrated embodiment, the second dimming interface resistor 616 has a resistance of approximately 15,000 ohms. Thus, a substantially constant current of approximately 167 microamperes flows through the second dimming interface resistor. The current cannot flow through the reverse-biased first dimming interface diode 630. Rather, the current flows from the fourth dimming interface capacitor 662, through the third dimming interface resistor 640, through the second dimming interface diode 642, through the dimming controller (not shown), through the first dimming interface resistor 612, and through the second dimming interface resistor. Each of the first dimming interface resistor and the second dimming interface resistor also has a resistance of approximately 15,000 ohms. Thus, the voltage drop across each resistor is also approximately 2.5 volts. The second dimming interface diode 642 has a forward voltage drop of approximately 0.7 volt. Accordingly, the total voltage drop V_{TOTAL} from the input section voltage node 632 to the dimming interface ground reference 620 is calculated in accordance with the following Equation (1):

V_{TOTAL}=2.5V+0.7V+V_{DIMMING}+2.5V+2.5V=V_{DIMMING}+8.2V (1)

In Equation (1), V_{DIMMING} represents the voltage across the input capacitor 610 provided by the dimming controller (not shown). Thus, when the dimming voltage is 0 volts, the total voltage (V_{TOTAL}) is 8.2 volts. When the dimming voltage is 9 volts, the total voltage is 17.2 volts. Accordingly, the dimming voltage plus an offset voltage of 8.2 volts appears across the programmable reference 650. The programmable reference operates to clamp the voltage across the programmable reference to maintain the voltage on the reference node 614 at 2.5 volts and thus maintain the current through the second dimming interface resistor 616 at 2.5 microamperes. If the dimming voltage increases, the programmable reference increases the maximum clamped voltage on the input section voltage node 632 to maintain the voltage relationship shown in Equation (1). If the dimming voltage decreases, the programmable reference decreases the maximum clamped voltage on the input section voltage node.

The voltage on the input section voltage node 632 is the voltage across the fourth dimming interface capacitor 662. The voltage across the fourth dimming interface capacitor is clamped to a maximum of 18.2 volts by the Zener diode 660. The fourth dimming interface capacitor is charged by current from the first terminal 674 of the first secondary winding 672 of the dimming interface isolation transformer 670. The dimming interface isolation transformer has a primary winding 700 having a respective first terminal 702 and a respective second terminal 704. The dimming interface isolation transformer has a second secondary winding 710 that has a respective first terminal 712 and a respective second terminal 714.

The second terminal 704 of the primary winding 700 of the dimming interface isolation transformer 670 is connected to a 5-volt supply bus 720, which is referenced to the secondary ground reference 332. A local filter capacitor 722 may also be connected between the 5-volt supply bus and the secondary ground reference. The first terminal 702 of the primary winding is connected to a drain terminal 732 of a power MOSFET 730. A source terminal 734 of the power MOSFET is connected to the secondary ground reference. A gate terminal 736 of the power MOSFET is connected to the secondary ground reference by a pulldown resistor 740. The gate terminal is also connected to the GATE_DRV input terminal 524 by an input resistor 742. An anode of a Zener diode 746 is connected to the secondary ground reference. A cathode of the Zener diode is connected to the drain terminal of the MOSFET and to the first terminal of the primary winding.

The second terminal 714 of the second secondary winding 710 of the dimming interface isolation transformer 670 is connected to the secondary ground reference 332. The first terminal of the second secondary winding is connected to an anode of an output diode 750. A cathode of the output diode is connected to a dimming interface output node 752. An output node filter capacitor 754 is connected from the dimming interface output node to the secondary ground reference. A first output voltage divider resistor 756 is connected from the dimming interface output node to the DIM_LEVEL output terminal 522, which is connected to the dimming level input terminal 510 of the microcontroller 500. The dimming level input terminal of the microcontroller is also connected to the secondary ground reference via a second output voltage divider resistor 760. In the illustrated embodiment, the high-impedance output resistor has a resistance of approximately 27,400 ohms and the voltage divider resistor has a resistance of approximately 9,090 ohms. Thus, the voltage applied to the dimming level input terminal of the microcontroller is attenuated to approximately 25% of the voltage on the dimming interface output node.

The microcontroller 500 communicates with the dimmer interface 520 by applying pulses to the gate drive signal from the GATE_DRV output terminal 512 to the GATE_DRV input terminal 524 of the dimmer interface. In the illustrated embodiment, the pulses have a repetition rate of approximately 37 kHz and have a duty cycle of approximately 6%. When the gate drive signal is active high, a positive voltage is applied to the gate terminal 736 of the power MOSFET 730 via the input resistor 744 to turn the MOSFET on. Turning on the MOSFET causes current to flow from the 5-volt supply bus 720 into the second terminal 704 of the primary winding 700 of the dimming interface isolation transformer 670, through the primary winding, out of the first terminal 702 of the primary winding and through the MOSFET to the secondary ground reference 332. The current flowing through the primary winding induces a corresponding current flow through the first secondary winding 672 of the dimming interface isolation transformer. The induced current flows out of the first terminal 674 of the first secondary winding and charges the fourth dimming interface capacitor 662. The maximum voltage across the fourth dimming interface capacitor is limited by the maximum voltage on the input section voltage node 632, which is controlled by the programmable reference 650 in response to the dimming control input voltage, as described above. The periodic charging of the fourth dimming interface capacitor maintains the voltage on the input voltage section voltage node substantially constant at V_{DIMMING}+8.2 volts.

The current flowing through the primary winding 700 of the dimming interface isolation transformer 670 also induces a current to flow out of the first terminal 712 of the second secondary winding 710 of the dimming interface isolation transformer 670 through the output diode 750 to the dimming interface output node 752 to thereby charge the output node filter capacitor 754. The maximum voltage across the output node filter capacitor is limited by the voltage across the fourth dimming interface capacitor 662 and is thus limited by the maximum voltage on the input section voltage node 632 as described above. Thus, the voltage on the output node is responsive to the dimming voltage applied between the dimming level high input terminal 530 and a dimming level low input terminal 532 of the dimming interface 520. In the illustrated embodiment, the primary winding 700, the second secondary winding 710 and the first secondary winding 672 of the dimming interface isolation transformer have the same or substantially the same number of turns such that the winding ratio is 1:1:1. Thus, the voltage appearing across the output node filter capacitor is the same or substantially the same as the voltage on the input section voltage node as defined by Equation (1) above (e.g., V_{DIMMING}+8.2 volts). The voltage across the output node filter capacitor is referenced to the secondary ground reference 332, which is isolated from the isolated ground reference

The voltage across the output node filter capacitor 754 is applied to the dimming level high input terminal 510 of the microcontroller via the first output voltage divider resistor 756. The voltage is attenuated by the voltage divider of the first voltage divider resistor and the second output voltage divider resistor 760 to approximately 25% of the voltage across the output node filter capacitor (e.g., ((V_{DIMMING}++8.2)/4). The voltage on the dimming level input terminal of the microcontroller is an analog voltage. The microcontroller includes an internal analog-to-digital converter (ADC) that converts the measured analog voltage to a digital representation. The microcontroller then converts the digital representation of the measured analog voltage to a digital representation of the dimming voltage input in accordance with the following Equation (2):

V_{CALC}=OFFSET+(SLOPE×V_{MEAS}) (2)

In Equation (2) V_{CALC} is the microcontroller's calculation of the dimming voltage applied across the two dimming inputs (the dimming level high input terminal 530 and the dimming level low input terminal 532) of the dimming interface 520, and V_{MEAS} is the measured voltage on the DIM_LEVEL input terminal 510 of the microcontroller 500, which is attenuated (e.g., to 25%) from the voltage on the dimming interface output node 752. Ideally, the offset and the slope of Equation (2) would be measured characteristics of the dimming interface and the attenuation circuit (e.g., the first output voltage divider resistor 756 and the second output voltage divider resistor 760), which would be determined during development of the LED driver 100 and which would be hard coded into the firmware of the microcontroller or stored with non-volatile memory within the microcontroller. The hard-coded information would be used by the microcontroller to calculate the output current setpoint in accordance with the following Equation (3):

I_{OUT}=I_{MIN}+((I_{MAX}−I_{MIN})×((V_{CALC}−V_{FULLDIM})/(V_{FULLBRIGHT}−V_{FULLDIM}))) (3)

In Equation (3), I_{OUT} is generated load current setpoint; V_{FULLDIM} is the lowest voltage of the control signal to produce a minimum load current; V_{FULLBRIGHT} is the highest voltage of the control signal to produce a maximum LED current; I_{MIN} is a minimum load current setpoint corresponding to the control signal being received at V_{FULLDIM}; and I_{MAX} is a maximum load current setpoint corresponding to the control voltage being received at V_{FULLBRIGHT}. The parameters I_{MAX}, I_{MIN}, V_{FULLDIM}, and V_{FULLBRIGHT} can be hard coded into the microcontroller firmware or stored in non-volatile memory. The parameters can also be configured using the NFC circuit 550. However, it should be understood that the determination of V_{CALC} depends on the value of V_{MEAS}, which is determined from the actual dimming voltage applied across the dimming level high input terminal 530 and the dimming level low input terminal 532 of the dimming interface 520. Because of component tolerances (e.g., the resistance values of the resistors in the dimming interface) and variations in the construction of the dimming interface isolation transformer 670, the offset and the slope in Equation (2) can vary from LED driver to LED driver. Thus, hard coding of the slope and offset parameters based on the nominal values of the resistive components and the nominal characteristics of the dimming interface isolation transformer would result in inaccurate determinations of the output current setpoint for many of the LED drivers 100.

Rather than rely on hard-coded constant values for slope and offset in Equation (2), the specific values are determined for each individual LED driver 100 as part of the manufacturing process. The constant values are saved to non-volatile memory within the microcontroller 500 via the NFC circuit 550. As described below, the configuration commands are stored in the NFC circuit while the LED driver is not powered. When the LED driver is powered on, the microcontroller reads and parses the configuration commands stored in the NFC circuit. To accomplish the calibration described herein, a calibration initialization command is stored in the NFC circuit. The microcontroller is programmed with a routine in firmware that operates as a state machine that accesses the calibration initialization command and that parses the calibration initialization command in conjunction with manufacturing test equipment. The format of the calibration initialization command is described below.

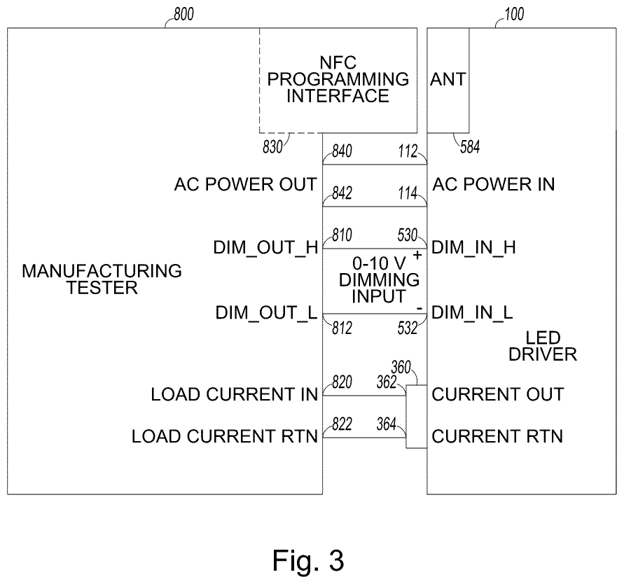

FIG. 3 illustrates a block diagram of the LED driver 100 coupled to a manufacturing tester 800. As illustrated, the LED driver receives dimming voltage via the dimming level high (DIM_IN_H) input terminal 530 and the dimming level low input (DIM_IN_L) terminal 532. The dimming voltage is provided by the manufacturing tester via a respective first DIM_OUT_H output terminal 810 and a second DIM_OUT_L output terminal 812. The manufacturing tester is programmed to generate varying levels of the dimming voltage as part of a testing routine described below.

The manufacturing tester 800 includes a load current input terminal 820 and a load current return terminal 822. The load current input terminal manufacturing tester is connected to the first (power) terminal 362 of the output connector 360 of the LED driver 100. The current return terminal of the manufacturing tester is connected to the second (return) terminal 364 of the output connector. The manufacturing tester includes an internal load (not shown) that corresponds to the LED load 110. The manufacturing tester also includes an internal current sensor that measures the current flowing through the internal load.

The manufacturing tester 800 further includes an NFC programming interface 830 that is configured to communicate with the NFC circuit 550 of the LED driver 100 when the antenna 584 of NFC circuit is positioned near the NFC programming interface. When the NFC programming interface is activated with the LED driver powered off, the manufacturing tester transfers the calibration initialization command to the NFC circuit of the LED driver. Techniques for communicating to an NFC circuit are well known and understood and are not described herein.

The manufacturing tester 800 further includes an internal AC power source (not shown) that provides AC power to the LED driver 100 from a first AC voltage output terminal 840 and a second AC voltage output terminal 842 to the first AC voltage input terminal 112 and the second AC voltage input terminal 114. After transferring the calibration initialization command to the LED driver, the manufacturing tester applies AC power to the LED driver and activates the test protocol described below.

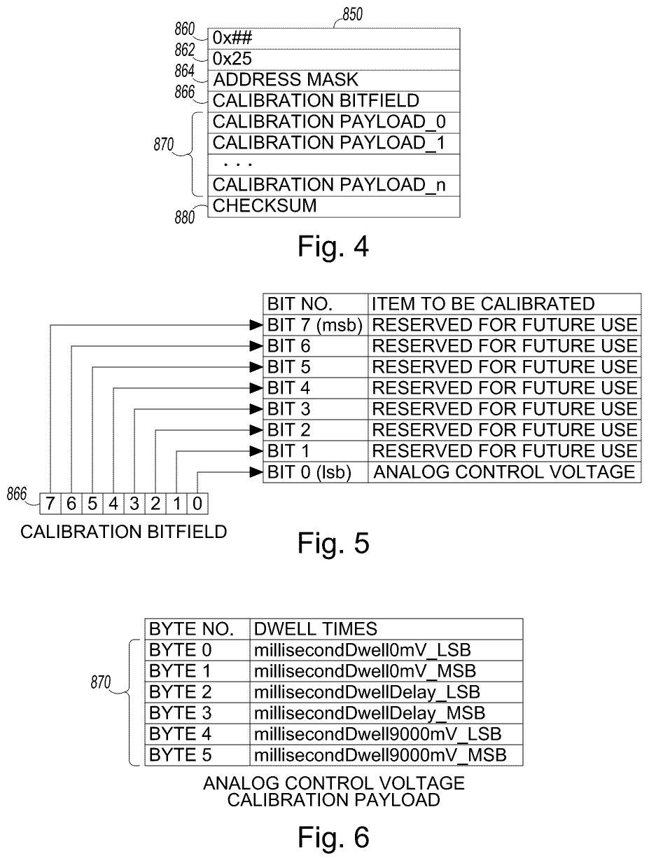

FIG. 4 illustrates an example of a calibration initialization command 850 comprising a plurality of bytes of data received by the NFC circuit 550 from the manufacturing tester 800. A first byte 860 in the plurality of bytes identifies the total length of the command in bytes. The first byte is a hexadecimal number having the format 0x ## where “0x” is the conventional notation indicating that the value™ # is a hexadecimal number that ranges from 00 to FF (0 to 255 decimal). In the illustrated embodiment described herein, the calibration initialization command comprises eleven bytes. Thus, the first byte has a hexadecimal value of 0x0B

A second byte 862 is a command number that identifies the type of command stored in the plurality of bytes. In the illustrated embodiment, the value of the second byte is 0x25, which indicates to the microcontroller 500 that the command is to initialize calibration as described below. The second byte may be other values to indicate other commands to be performed by the microcontroller, which are not discussed herein.

A third byte 864 is an address mask byte that may be used when multiple LED drivers 100 are bussed together. The address mask byte is set to 0x00 in the illustrated embodiment.

A fourth byte 866 comprises an eight-bit field (calibration bit field) wherein each bit may designate a different item to be calibrated. The fourth byte is shown in more detail in FIG. 5. In the annotation used herein, the most significant bit (msb) is designated as bit 7 and the least significant bit (lsb) is designated at bit 0. If bit 0 is set (e.g., a logical 1), the analog control voltage is being calibrated as described herein. The other seven bits are reserved for future use for other parameters to be calibrated and are not used in the embodiment disclosed herein.

The next n bytes 870 of the stored command comprises calibration payload information. The value of n varies in accordance with the type of calibration being performed. In the illustrated embodiment, the value of n is six and the command comprises Calibration Payload Byte 0, Calibration Payload Byte 1, Calibration Payload Byte 2, Calibration Payload Byte 3, Calibration Payload Byte 4, and Calibration Payload Byte 5 as shown in FIG. 6, which is discussed below.

A last byte 880 in the calibration initialization command is a checksum byte that is generated by adding the previous n+4 bytes and ANDing the resulting sum with 0xFF to generate a one-byte checksum value. The microcontroller 500 confirms that the checksum value is correct before performing the calibration procedure.

FIG. 6 illustrates six (e.g., n=6) calibration payload bytes for the calibration initialization command described herein. Calibration Payload Byte 0 comprises a least significant byte (millisecondDwell0 mV_LSB) of a dwell time for the microcontroller 500 to generate an output current setpoint corresponding to a dimming input voltage of 0 millivolts. Calibration Payload Byte 1 comprises a most significant byte (millisecondDwell0 mV_MSB) of a dwell time for the microcontroller to generate an output current setpoint corresponding to a dimming input voltage of 0 millivolts. The two bytes are combined to identify a 0 millivolt dwell time in milliseconds (millisecondDwell0 mV). For example, if Calibration Payload Byte 1 is set to 0x03 and Calibration Payload Byte 0 is set to 0xE8, the dwell time at 0 millivolts is set to 0x03E8, which corresponds to 1,000 milliseconds or 1 second. The 0 millivolt dwell time specifies how long the microcontroller dwells at the initial output current setpoint before storing a calibration value and moving to the next setpoint.

In similar manner, Calibration Payload Byte 2 and Calibration Payload Byte 3 are the least significant byte (millisecondDwellDelay_MSB) and the most significant byte (millisecondDwellDelay_MSB), respectively, for a delay dwell time while the output current setpoint is set at a value representing approximately one-half the maximum output current. Together, the least significant byte and the most significant byte define a delay dwell time (millisecondDwellDelay) during which the output current is maintained at the half-maximum value. As discussed below, when the manufacturing tester 800 measures the current at the half-maximum value, the manufacturing tester changes the dimming voltage level applied to the LED driver 100.

In similar manner, Calibration Payload Byte 4 and Calibration Payload Byte 5 are the least significant byte (millisecondDwell9000 mV_LSB) and the most significant byte (millisecondDwell9000 mV_MSB), respectively, for a dwell time while the output current setpoint is set at a value representing the maximum output current when the dimming voltage set to 9,000 millivolts (i.e., 9 volts). The two bytes are combined to identify a 9000 millivolt dwell time in milliseconds (millisecondDwell0 mV).

Once the calibration command is written to the NFC circuit 550, the manufacturing tester 800 powers on the LED driver 100 and initially applies 0 volts across the first DIM_OUT_H output terminal 810 and the second DIM_OUT_L output terminal 812 and thus applies dimming voltage of 0 volts via the dimming level high input terminal 530 and the dimming level low input terminal 532 of the LED driver.

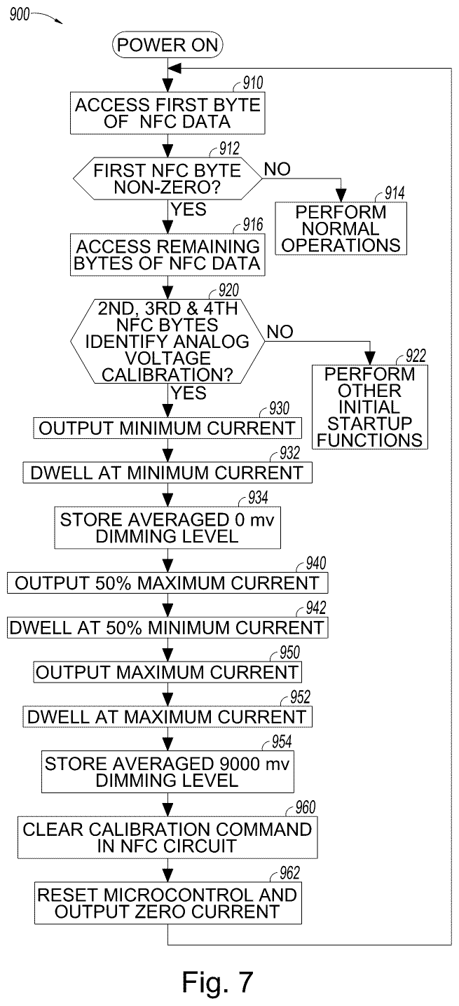

When the manufacturing tester 800 powers on LED driver 100, the microcontroller 500 begins executing a program/state machine 900 illustrated in FIG. 7. The microcontroller initially applies power to the NFC circuit 550 by activating the voltage output terminal 560 to provide voltage to the voltage supply terminal 570 of the NFC circuit. In an activity block 910, the microcontroller accesses the first data byte 860 stored in the NFC circuit via the serial data line 576 in synchronism with a serial clock signal on the serial clock line 578. In a decision block 912, the microcontroller determines whether the first data byte represents a non-zero value corresponding to a number of bytes to transfer from the NFC circuit to internal storage within the microcontroller. If the first byte has a zero value, the microcontroller determines that a calibration procedure is not to be performed and advances to an activity block 914, wherein the LED driver performs normal operational activities. If the first byte has a non-zero value, the microcontroller transfers the data to internal storage in an activity block 916. The microcontroller verifies the checksum value as part of the transfer process.

After storing the data from the NFC circuit 550, the microcontroller 500 advances to a decision block 920, wherein the microcontroller accesses the stored data and verifies that the second byte 862 contains the value 0x25. The microcontroller also verifies that the third (address mask) byte 864 is set to 0x00 in the illustrated embodiment or to another selected value for alternative embodiments. The microcontroller also verifies that the least significant bit of the fourth byte 866 is set to indicate that the analog voltage calibration is to be performed. If at least one or more of the foregoing bytes does not have the correct value for the calibration procedure, the microcontroller bypasses the initialization process and proceeds to an activity block 922, which may include other tasks to be performed in response to different values in the accessed bytes.

If the second byte 862 contains the value 0x25 and if the address mask byte 864 is set to 0x00 and if the analog voltage calibration bit (e.g., the least significant bit 0) is set in the fourth byte 866, the microcontroller 500 advances from the decision block 920 to an activity block 930 wherein the microcontroller begins the calibration process. In the activity block 930, the microcontroller outputs a current setpoint value on the I_SET output terminal 502 to cause the LED driver 100 to generate a minimum dim current. In an activity block 932, the microcontroller dwells at the minimum dim current for a selected duration. As discussed above, the 0 millivolt dwell time at the minimum dim current is determined by the millisecondDwell0 mV value obtained by combining the least significant byte of Calibration Payload Byte 0 and the most significant byte of Calibration Payload Byte 1 in the six calibration payload bytes 870 illustrated in FIG. 6. While dwelling at the minimum dim current value, the microcontroller continuously samples the attenuated dimming level input voltage on the dimming level input terminal 510. The microcontroller averages the dimming level input voltage samples to generate an averaged dimming voltage measurement.

After waiting the selected dwell time while outputting the current setpoint value for the minimum dimming current, the microcontroller 500 advances to an activity block 934 wherein the microcontroller stores the averaged dimming voltage measurement for 0 volts dimming input.

After storing the averaged dimming voltage measurement at 0 volts dimming input, the microcontroller advances to an activity block 940 wherein the microcontroller temporarily adjusts the output current setpoint to approximately 50% of the maximum value. In an activity block 942, the microcontroller dwells at this output current value for the value millisecondDwellDelay before advancing to an activity block 950. As discussed below, the manufacturing tester 800 senses the current at the 50% maximum value (half-maximum value) and responds by changing the dimming voltage input to 9,000 millivolts (9 volts).

After delaying for the selected delay time, the microcontroller 500 advances to an activity block 952 and inputs the dimming level voltage on the dimming level input terminal 510. The microcontroller also adjusts the output current setpoint on the I_SET output terminal to a current value corresponding to the maximum current. For a time corresponding to the stored 9000 millivolt time (millisecondDwell9000 mV), the microcontroller remains in the activity block 952 and continuously samples the attenuated dimming level input voltage on the dimming level input terminal 510. The microcontroller averages the dimming level input voltage samples to generate an averaged dimming voltage measurement corresponding to 9,000 millivolts.

After waiting the selected dwell time while outputting the current setpoint value for the maximum dimming current, the microcontroller 500 advances from the activity block 952 to an activity block 954 wherein the microcontroller stores the averaged dimming voltage measurement for 9,000 millivolts dimming input.

After storing the averaged dimming voltage measurement for 9,000 millivolts input, the microcontroller 500 advances to an activity block 960 wherein the microcontroller accesses the NFC circuit 550 to clear the calibration command data stored in the NFC circuit. After clearing the calibration command data, the microcontroller advances to an activity block 962 wherein the microcontroller resets itself. The reset causes the microcontroller to output a current setpoint value corresponding to zero current. This causes the current provided to the manufacturing tester 800 to reduce to zero current. The manufacturing tester senses the zero current to determine that the calibration process is compete. When the microcontroller begins operating after the reset, the microcontroller accesses the NFC circuit in the activity block 910 as previously described; however, because the NFC circuit no longer contains the calibration command data, the microcontroller begins operating in a normal mode using the dimming coefficients determined during the calibration process to convert the dimming voltage inputs to calibrated dimming voltage inputs as described below.

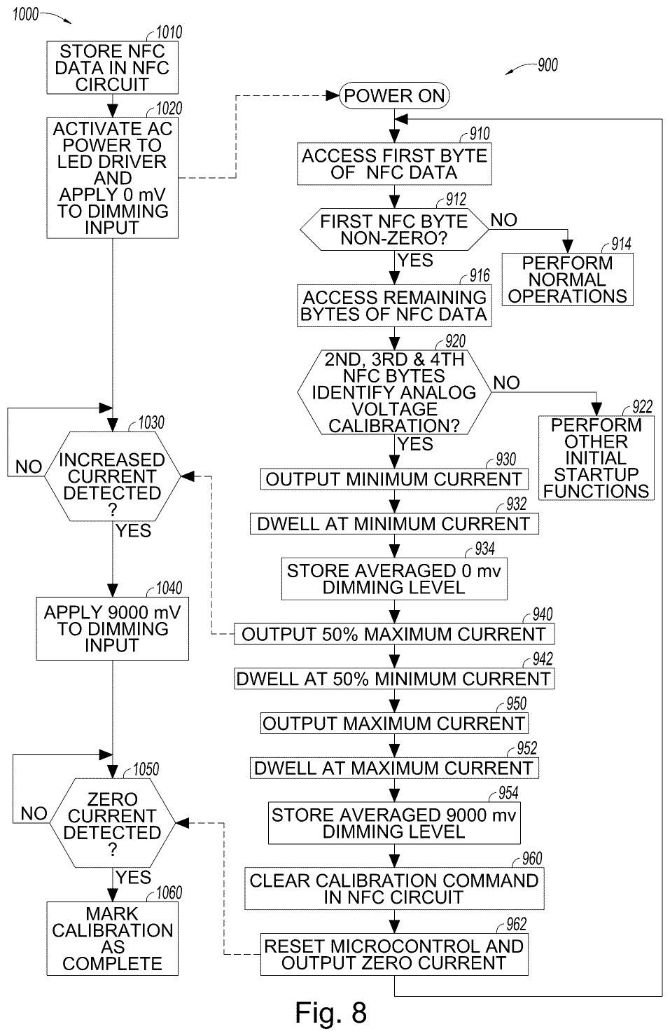

The foregoing interaction between the LED driver 100 and the manufacturing tester 800 can be understood visually as two state machines operating in parallel and communicating with each other as illustrated in FIG. 8. In FIG. 8, the program/state machine 900 implemented by the microcontroller 500 is presented as before and operates as explained above. A flowchart 1000 represents a program/state machine implemented in the manufacturing tester to control the LED driver and to monitor the current provided by the LED driver. Dashed flow lines interconnecting the two flowcharts represent the interactions between the two state machines. Prior to applying AC power to the LED driver, the manufacturing tester, executes an activity block 1010 wherein the manufacturing tester stores the data representing the calibration command into the NFC circuit 550 via the antenna 584. The NFC programming interface 830 of the manufacturing tester provides power to the NFC circuit in a conventional manner.

After storing the calibration command in the NFC circuit 550, the manufacturing tester 800 executes an activity block 1020 wherein the manufacturing tester supplies AC power to the LED driver and applies 0 volts as an initial dimming voltage across the first DIM_OUT_H output terminal 810 and the second DIM_OUT_L output terminal 812, which applies dimming voltage of 0 volts via the dimming level high input terminal 530 and the dimming level low input terminal 532 of the LED driver. The manufacturing tester then advances to a decision block 1030 wherein the manufacturing tester measures the load current provided by the LED driver and determines whether the measured current has increased to a substantial non-zero magnitude. If the current has not increased, the manufacturing tester continues to measure the current in the activity block 1030.

When the manufacturing tester 800 detects a substantial increase in the measured current, the manufacturing tester advances from the decision block 1030 to an activity block 1040 wherein the manufacturing tester adjusts the dimming voltage applied to the LED driver 100 to 9,000 millivolts (9 volts). The manufacturing tester then advances to a decision block 1050 wherein the manufacturing tester measures the current provided by the LED driver and determines whether the current has decreased to zero or near zero (e.g., determines whether the current exhibits a dropout). If the current has not dropped out, the manufacturing tester returns to the activity block 1050 and continues to measure the current. If the current has dropped out, the manufacturing tester advances to a decision block 1060 and marks the current test as complete. The manufacturing tester may then disable power to the LED driver and apply zero volts to the dimming input, or the manufacturing tester may be used to perform other tests on the LED driver.

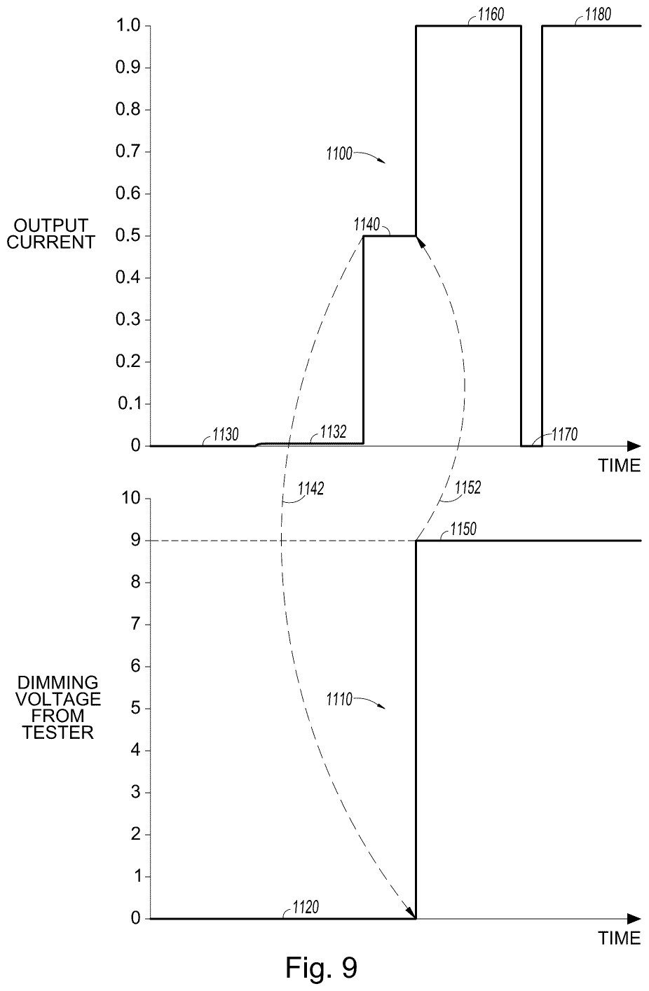

FIG. 9 illustrates a current waveform 1100 generated by the LED driver 100 and a voltage waveform 1110 generated by the manufacturing tester 800 during the calibration procedure described above. As illustrated by a first portion 1120 of the voltage waveform, the manufacturing tester initially applies 0 volts to the dimming inputs of the LED driver. As illustrated by a corresponding first portion 1130 of the current waveform, the LED driver initially generates zero current when first powered on. In the illustrated embodiment, the LED driver then generates a small non-zero current during a second portion 1132 of the current waveform for a duration corresponding to the 0 millivolt dwell time. In other embodiments, the second portion of the current waveform may also be zero. During the time when the LED driver is generating the second portion of the current waveform, the microcontroller 500 samples and averages the attenuated dimming level voltage on the dimming level input terminal 510 and then stores the average as the first value V_{0mV} as described above.

After storing the first value, the microcontroller 500 causes the LED driver 100 to output the current at a second level during a third portion 1140 of the current waveform 1100. As discussed above, the second level is approximately 50% of the maximum current level. The LED driver continues to output current at this level for the duration of the delay dwell time.

As illustrated by a first dashed arcuate arrow 1142 extending from the current waveform 1100 to the voltage waveform 1110, the manufacturing tester 800 responds to the measurement of the current at the 50% maximum level by switching the dimming voltage to 9,000 millivolts (9 volts) as represented by a second portion 1150 of the voltage waveform. As illustrated by a second dashed arcuate arrow 1152 extending from the voltage waveform 1100 to the voltage waveform 1110, the LED driver 100 responds to the increased dimming voltage by switching the current to a level corresponding to a 9,000-millivolt dimming level as illustrated by a fourth portion 1160 of the current waveform 1100. The LED driver maintains the current at this level for the duration of the 9000 millivolt dwell time and then switches the current to a zero level as illustrated by a fifth portion 1170 of the current waveform. As discussed above, the zero level of the output current inform the manufacturing tester that the calibration procedure is complete. The current is maintained at the zero level for a short time (e.g., a few milliseconds) whiled the microcontroller 500 resets itself and restarts. Upon restart, the microcontroller reads the NFC circuit 550 as before; however, since the microcontroller has cleared the calibration command from the NFC circuit, the microcontroller determines that the first byte 860 is zero in the decision block 912 (FIGS. 7 and 8) and advances to the activity block 914 to perform normal operations. If the manufacturing tester maintains 9,000 millivolts as the dimming voltage, the LED driver will again produce the maximum output current corresponding to a the 9,000-millivolt input as shown by a sixth portion 1180 of the current waveform in FIG. 9.

As discussed above, when the calibration process is complete, the microcontroller 500 has two values stored in non-volatile memory. A first value corresponds to the average value of the attenuated voltage applied to the dimming level input terminal 510 of the microcontroller when the manufacturing tester 800 applied 0 millivolts across the dimming level high input terminal 530 and the dimming level low input terminal 532 of the LED driver. For the following discussion, the first value is referred to as V_{0mV}. The second value corresponds to the average value of the attenuated voltage applied to the dimming level input terminal when the manufacturing testers applied 9,000 millivolts across the dimming level high input terminal and the dimming level low input terminal of the LED driver. For the following discussion, the second value is referred to as V_{9000mV}. With respect to Equation (2), the offset value corresponds to the first value V_{0mV}. The slope in Equation (2) is determined as:

SLOPE=(V_{9000mV}−V_{0mV})/9000 (4)

The slope and the offset value are stored at the conclusion of the above-described calibration procedure and are used by the microcontroller 500 each time the LED driver 100 is powered on to convert the measured attenuated dimming level V_{MEAS} to the calibrated dimming level V_{CALC} in accordance with Equation (2) reproduced below:

V_{CALC}=OFFSET+(SLOPE×V_{MEAS}) (2)

The calibrated dimming level V_{CALC} is then used by the microcontroller 500 to determine the output current setpoint in accordance with Equation (3) reproduced below:

I_{OUT}=I_{MIN}+((I_{MAX}−I_{MIN})×((V_{CALC}−V_{FULLDIM})/(V_{FULLBRIGHT}−V_{FULLDIM}))) (3)

As previously described, I_{OUT} is generated load current setpoint; V_{FULLDIM} is the lowest voltage of the control signal to produce a minimum load current; V_{FULLBRIGHT} is the highest voltage of the control signal to produce a maximum LED current; I_{MIN} is a minimum load current setpoint corresponding to the control signal being received at V_{FULLDIM}; and I_{MAX} is a maximum load current setpoint corresponding to the control voltage being received at V_{FULLBRIGHT}. As illustrated herein, V_{FULLDIM} is greater than zero; however, the 0-10 volt dimming control voltage can be decreased below V_{FULLDIM} to turn of the LED current entirely. Similarly, V_{FULLBRIGHT} is less than 10 volts; however, the 0-10 volt dimming control voltage may be greater than V_{FULLBRIGHT}. In the illustrated operation, the internal computation of V_{CALC} is clamped between V_{FULLDIM} and V_{FULLBRIGHT} to stay within the calibrated range.

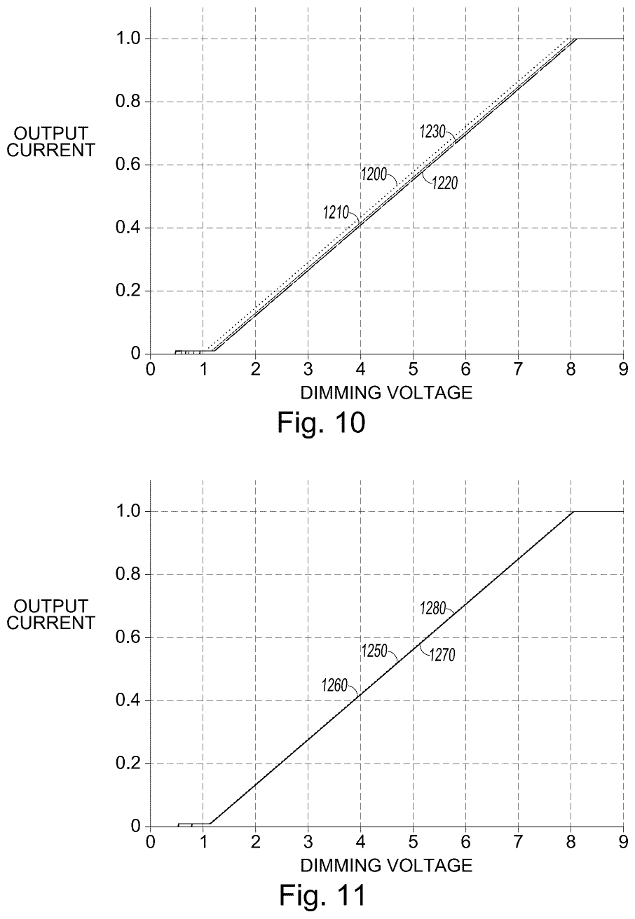

The improvement provided by the calibration method disclosed herein is shown by a set of four graphs in FIG. 10 representing the dimming curves of four uncalibrated LED drivers and by a corresponding set of four graphs in FIG. 10 for the same four LED drivers after calibration. The four tested LED drivers are configured to output full current at a target dimming voltage of 8 volts, to output a minimum current at approximately 1 volt, and to output zero current at or below 0.5 volt.

In FIG. 10, a first dotted graph 1200 represents the normalized output current (vertical axis) versus the dimming voltage (horizontal axis) for a first device prior to calibration. A second dashed graph 1210 represents the corresponding relationship for a second device prior to calibration. A third dash-dot-dot-dot graph 1220 represents the corresponding relationship for a third device prior to calibration. A fourth long dash-short dash 1230 represents the corresponding relationship for a fourth device prior to calibration. In FIG. 11, a first dotted graph 1250 represents the normalized output current versus the dimming voltage for the first device after calibration. A second dashed graph 1260 represents the corresponding relationship for the second device after calibration. A third dash-dot-dot-dot graph 1270 represents the corresponding relationship for the third device after calibration. A fourth long dash-short dash graph 1280 represents the corresponding relationship for the fourth device after calibration.

As shown in FIG. 10, the curves for the uncalibrated devices differ significantly. For example, at each dimming voltage, the normalized output current for the first device (dotted graph 1200) is significantly greater than the normalized output current for the fourth device (long dash-short dash graph 1230). Although the differences in the two graphs do not appear to be substantial, if the two devices controlled respective LED loads in close proximity, the difference in the light provided by the two LED loads would be quite noticeable.

In contrast to the graphs in FIG. 10, the corresponding graphs illustrated in FIG. 10 for the calibrated devices are much closer to each other.

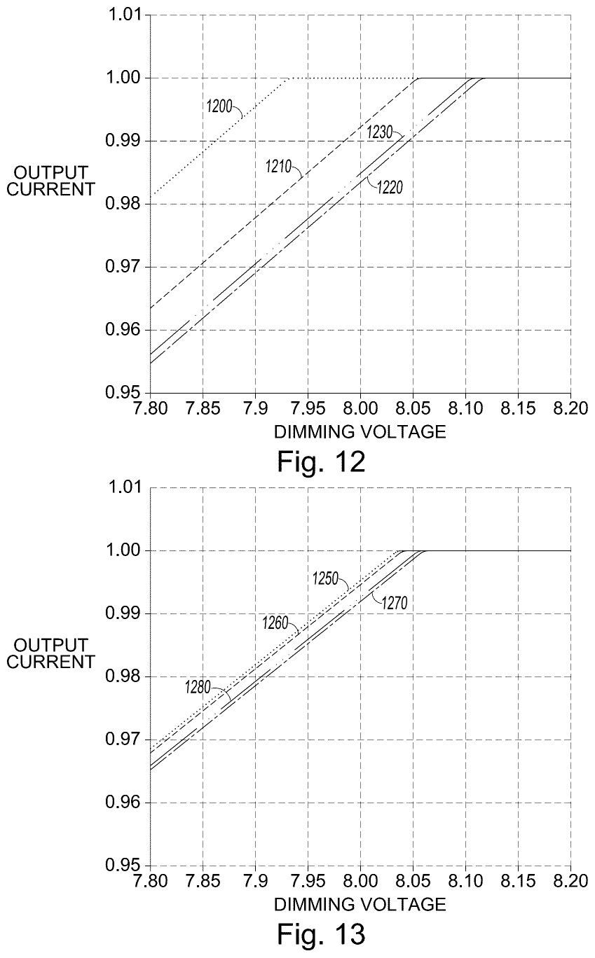

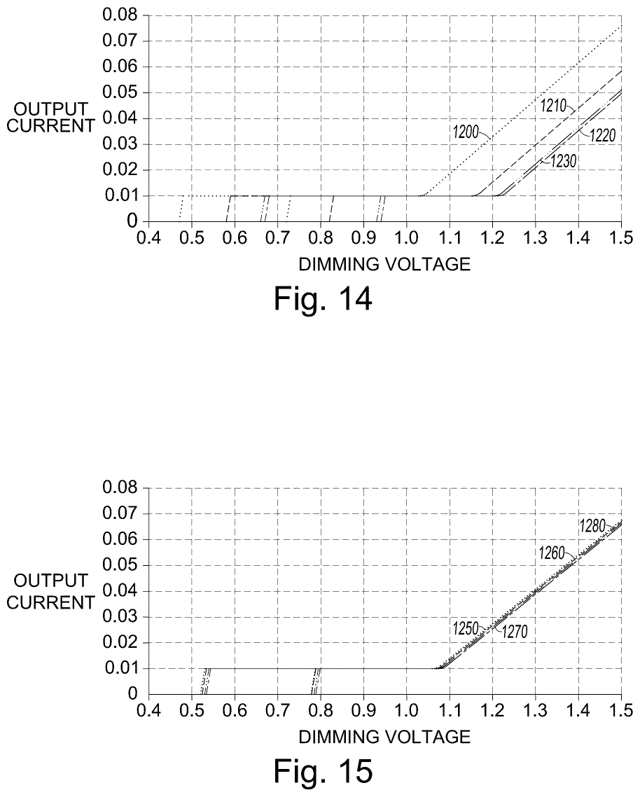

The differences between the devices before calibration and the devices after calibration are more apparent in FIG. 12 and FIG. 13, which illustrate the high current elbows (the transitions from rising currents to steady-state currents) before calibration (FIG. 12) and after calibration (FIG. 13) at enlarged scales. FIG. 14 and FIG. 15 illustrate the low current elbows (the transitions from an initial minimum currents to rising currents) before calibration (FIG. 14) and after calibration (FIG. 15).

As illustrated in FIG. 12, the maximum current achieved by the uncalibrated devices occurs in a relatively wide range of dimming voltages. In contrast, as illustrated in FIG. 14, the maximum current is achieved by the calibrated devices over a much tighter range of voltages.

As illustrated in FIG. 14, the four devices prior to calibration turn on from zero current to an initial minimum current in a relatively wide range represented by the rightmost four transitions in FIG. 14. The four devices begin increasing current from the minimum current level to higher current levels over a relatively wide range of voltages. The four devices also demonstrate a relatively wide range of turn-off voltages represented by the leftmost four transitions in FIG. 14. In contrast, as illustrated in FIG. 15, the four devices after calibration demonstrate a well-defined turn-on/turn-off hysteresis wherein the four devices turn on in a relatively small range of voltages and turn off in a relatively small range voltages. The four calibrated devices begin increasing the current from the dim level to higher current levels at approximately the same voltages.

As illustrated by the graphs in FIGS. 10-15, the calibration method described herein provides a substantial improvement in the consistency of the current output responsive to the dimming voltage input, which enables lighting fixtures controlled by the devices to be grouped together and controlled by corresponding dimming voltage input values to provide consistent light from the grouped fixtures.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system for calibrating an LED driver that receives an AC power input, that generates an output current via a current output terminal and a current return terminal, that includes an externally accessible non-volatile memory, that is responsive to a 0-10 volt dimming control signal to generate an internal dimming signal, and that varies a magnitude of the output current responsive to the internal dimming signal, the system comprising:
a tester configured to:
store a calibration command in the externally accessible non-volatile memory of the LED driver;
selectively provide AC power to the AC power input of the LED driver;
receive and measure the output current from the LED driver; and
provide at least first voltage and a second voltage as 0-10 volt dimming control signals to the LED driver, the tester providing the first voltage to the LED driver when power is applied to the AC power input of the LED driver, the first voltage of the control signal corresponding to a minimum current magnitude to be generated by the LED driver, the tester providing the second voltage of the control signal to the LED driver when the output current increases from a first minimum current magnitude to a second current magnitude, the second current magnitude less than a maximum magnitude of the output current, the second voltage of the control signal corresponding to a maximum current magnitude to be provided by the LED driver;
and
a state machine within the LED driver, the state machine configured to:
access the non-volatile memory to receive the calibration command;
generate the output current at the minimum current magnitude and determine a first value of the internal dimming signal corresponding to the first value of the control signal;
generate the output current at the second current magnitude;
detect the increase of the internal dimming signal to the second value;
generate the output current at the maximum current level and determine a second value of an internal dimming signal corresponding to the second value of the control signal; and
calculate a calibration relationship between the internal dimming signal wherein the calibration relationship comprises the first value of the internal dimming signal as an offset value and further comprises a slope determined by a difference between the second value and the first value of the internal dimming signal divided by a difference between the second voltage and the first voltage of the control signal.

2. The system as defined in claim 1, wherein the calibration relationship is stored within the LED driver and is used to determine the current level to generate each time the LED driver is turned on until a new calibration command is stored in the externally accessible non-volatile memory of the LED driver.

3. The system as defined in claim 1, wherein the state machine of the LED driver is configured to clear the calibration command stored in the externally accessible non-volatile memory after calculating the calibration relationship.

4. The system as defined in claim 1, wherein the state machine of the LED driver is configured to output a load current with a zero magnitude after calculating the calibration relationship as a to the tester that the calibration relationship has been calculated.

5. The system as defined in claim 1, wherein the calibration relationship comprises:
V_{CALC}=OFFSET+(SLOPE×V_{MEAS})
wherein:
V_{MEAS} is the value of the internal dimming signal responsive to the voltage of the dimming control signal applied to the LED driver;
V_{CALC} is an internal voltage that determines a current level to generate;
OFFSET is the first value of the internal dimming signal; and
SLOPE is the difference between the second value and the first value of the internal dimming signal divided by a difference between the second voltage and the first voltage of the control signal.

6. The system as defined in claim 5, wherein the LED driver is configured to generate a setpoint for the load current in accordance with:
I_{OUT}=I_{MIN}+((I_{MAX}−I_{MIN})×((V_{CALC}−V_{FULLDIM})/(V_{FULLBRIGHT}−V_{FULLDIM})))
wherein:
I_{ouT} is generated load current setpoint;
V_{FULLDIM} is the lowest voltage of the control signal to produce a minimum load current;
V_{FULLBRIGHT} is the highest voltage of the control signal to produce a maximum load current;
I_{MIN} is a minimum load current setpoint corresponding to the control signal being received at V_{FULLDIM}; and
I_{MAX} is a maximum load current setpoint corresponding to the control voltage being received at V_{FULLBRIGHT}.

7. The system as defined in claim 1, wherein the LED driver is configured to:
average the internal dimming signal over the first interval to generate a first average level;
average the internal dimming signal over the third interval to generate a second average level; and
generate the calibration relationship based on the first and second average levels of the internal dimming signal.

8. The system as defined in claim 7, wherein the calibration relationship is:
V_{CALC}=OFFSET+(SLOPE×V_{MEAS})
wherein:
V_{MEAS} is the value of the internal dimming signal responsive to the voltage of the dimming control signal applied to the LED driver;
V_{CALC} is the internal dimming signal that determines a current level to generate;
OFFSET is the first average level of the internal dimming signal; and
SLOPE is the difference between the second average and the first average level of the internal dimming signal divided by a difference between the second voltage and the first voltage of the control signal.

9. The system as defined in claim 8, wherein the LED driver is configured to generate a setpoint for the load current in accordance with:
I_{OUT}=I_{MIN}+((I_{MAX}−I_{MIN})×((V_{CALC}−V_{FULLDIM})/(V_{FULLBRIGHT}−V_{FULLDIM})))
wherein:
I_{OUT} is generated load current setpoint;
V_{FULLDIM} is the lowest voltage of the control signal to produce a minimum load current;
V_{FULLBRIGHT} is the highest voltage of the control signal to produce a maximum load current;
I_{MIN} is a minimum load current setpoint corresponding to the control signal being received at V_{FULLDIM}; and
I_{MAX} is a maximum load current setpoint corresponding to the control voltage being received at V_{FULLBRIGHT}.

10. A method of calibrating an LED driver that receives a 0-10 volt dimming control signal from an external source, that generates an internal dimming signal having values responsive to voltages of the 0-10 volt dimming control signal, and that outputs a load current having a magnitude responsive to the internal dimming signal, the method comprising:
storing a calibration command in a non-volatile memory of the LED driver;
accessing the calibration command in the non-volatile memory with a microcontroller within the LED driver;
receiving a known first voltage via the dimming control signal and generating an internal dimming signal at a first level responsive to the first voltage;
outputting the load current at a first magnitude for a first interval having a first selected duration;
outputting the load current at a second magnitude greater than the first magnitude for a second interval having a second selected duration;
receiving a known second voltage via the dimming control signal and generating the internal dimming signal at a second level responsive to the second voltage;
outputting the load current at a third magnitude greater than the second magnitude for a third interval having a third selected duration;
generating a calibrated relationship between the levels of the internal dimming signal and the voltages of the dimming control signal; and
storing the calibrated relationship to convert subsequent changes in the voltage of the dimming control signal to changes of the level of the internal dimming signal.

11. The method as defined in claim 10, further comprising outputting the load current at a fourth magnitude after storing the calibrated relationship.

12. The method as defined in claim 11, wherein the LED driver is configured to reset when outputting the load current at the fourth magnitude.

13. The method as defined in claim 11, wherein the fourth magnitude of the load current is substantially zero.

14. The method as defined in claim 10, wherein the control voltage is generated by an automated tester.

15. The method as defined in claim 10, wherein the LED driver clears the calibration command stored in the externally accessible non-volatile memory after generating the calibration relationship.

16. The method as defined in claim 10, wherein:
the internal dimming signal is averaged over the first interval to generate a first average level;
the internal dimming signal is averaged over the third interval to generate a second average level; and
the first average level and the second average level are used to generate the calibration relationship.

17. The method as defined in claim 16, wherein the calibration relationship is:
V_{CALC}=OFFSET+(SLOPE×V_{MEAS})
wherein:
V_{MEAS} is the value of the internal dimming signal responsive to the voltage of the dimming control signal applied to the LED driver;
V_{CALC} is the internal dimming signal that determines a current level to generate;
OFFSET is the first average level of the internal dimming signal; and
SLOPE is the difference between the second average and the first average level of the internal dimming signal divided by a difference between the second voltage and the first voltage of the control signal.

18. The method as defined in claim 17, wherein the LED driver generates a setpoint for the load current in accordance with:
I_{OUT}=I_{MIN}+((I_{MAX}−I_{MIN})×((V_{CALC}−V_{FULLDIM})/(V_{FULLBRIGHT}−V_{FULLDIM})))
wherein:
I_{ouT} is generated load current setpoint;
V_{FULLDIM} is the lowest voltage of the control signal to produce a minimum load current;
V_{FULLBRIGHT} is the highest voltage of the control signal to produce a maximum load current;
I_{MIN} is a minimum load current setpoint corresponding to the control signal being received at V_{FULLDIM}; and
I_{MAX} is a maximum load current setpoint corresponding to the control voltage being received at V_{FULLBRIGHT}.

19. The method as defined in claim 10, wherein the calibration relationship is:
V_{CALC}=OFFSET+(SLOPE×V_{MEAS})
wherein:
V_{MEAS} is the value of the internal dimming signal responsive to the voltage of the dimming control signal applied to the LED driver;
V_{CALC} is the internal dimming signal that determines a current level to generate;
OFFSET is the first level of the internal dimming signal; and
SLOPE is the difference between the second and the first level of the internal dimming signal divided by a difference between the second voltage and the first voltage of the control signal.

20. The method as defined in claim 19, wherein the LED driver generates a setpoint for the load current in accordance with:
I_{OUT}=I_{MIN}+((I_{MAX}−I_{MIN})×((V_{CALC}−V_{FULLDIM})/(V_{FULLBRIGHT}−V_{FULLDIM})))
wherein:
I_{ouT} is generated load current setpoint;
V_{FULLDIM} is the lowest voltage of the control signal to produce a minimum load current;
V_{FULLBRIGHT} is the highest voltage of the control signal to produce a maximum load current;
I_{MIN} is a minimum load current setpoint corresponding to the control signal being received at V_{FULLDIM}; and
I_{MAX} is a maximum load current setpoint corresponding to the control voltage being received at V_{FULLBRIGHT}.
